(19) United States
(12) Patent Application Publication
(10) Pub. No.: US 2008/0020349 A1
(43) Pub. Date: Jan. 24, 2008

(54) BONE IMPLANT

(76) Inventor: Roland Dricot, Dilbeek (BE)

Correspondence Address: HOVEY WILLIAMS LLP, 2405 GRAND BLVD., SUITE 400, KANSAS CITY, MO, 64108, US

(21) Appl. No.: 11/844,261

(22) Filed: Aug. 23, 2007

Related U.S. Application Data
(63) Continuation-in-part of application No. PCT/BE2005/000029, filed on Feb. 24, 2005.

(51) Int. Cl. A61C 8/00

(52) U.S. Cl. 433/174; 433/173

(57) ABSTRACT

Bone implant comprising a solid structure provided with an osteogenic layer comprising calcium phosphate in the form of particles (dihydrate and/or alphahemidrate) with a weight average particle size comprised between 10 μm and 250 μm.

This application is a continuation in part in the United States of international patent application PCT/BE2005/000029 filed on Feb. 24, 2005, and published on Aug. 31, 2006 under number WO2006/089380, the disclosure of which is incorporated herein by reference.

### BACKGROUND OF THE INVENTION

The subject of the present invention is an implant comprising a structure with an osteogenic coating comprising calcium phosphate in the form of particles (dihydrate and/or alphahemidrate) with a weight average particle size comprised between 10 μm and 250 μm, preferably consisting essentially of calcium sulphate, especially an implant for dental purposes or dental prothesis, as well as a method for the placement of an artificial teeth or a dental prothesis into the month of a patient in need. In said method, preferably bone is formed outside of a bone cavity, i.e. for forming a larger bone volume for ensuring a good fixation of the artificial tooth or teeth or dental prothesis.

### THE PRIOR ART

WO2004/054463 in the name of the same Applicant was published on Jul. 1, 2004. In said document, Applicant describes an implant equipped with an osteogenic coating. No description at all is given in said document to the use of calcium sulphate.

U.S. Pat. No. 5,385,887 discloses a composition comprising a pharmaceutical acceptable admixture of an osteogenic protein, a porous particulate polymer matrix, an osteogenic protein sequestring amount of blood clot, and a calcium sulfate hemihydrate-containing substance. No reference is made in said document to an implant comprising a solid structure provided with anchoring means, said solid structure being provided with a layer adapted to form a high volume of bone tissue after placement of the implant in and through the living bony part selected from the human upper maxilla and the human lower maxilla. Said document does not disclose an implant adapted to form bone tissue outside the living bone part, so as to ensure an increased adhesion of the implant.

U.S. Pat. No. 6,224,635 discloses techniques for the preparation of a calcium sulphate cement. No reference is made in said document to an implant comprising a solid structure provided with anchoring means, said solid structure being provided with a layer adapted to form a high volume of bone tissue after placement of the implant in and through the living bony part selected from the human upper maxilla and the human lower maxilla. Said document does not disclose an implant adapted to form bone tissue outside the living bone part, so as to ensure an increased adhesion of the implant.

The document U.S. Pat. No. 5,344,654 describes an implant coated with a virtually pure osteogenic protein coating. This is an intrabone implant, since it is designed to extend solely within a cavity created in a bone.

This implant inserted into a cavity created artificially in a bone has no means of fixing or positioning, fixing being achieved by the proliferation and differentiation of cells generating bony tissue. As long as the bone has not formed, the implant is not held in place correctly. The implant described in the document is not able to form a bone volume outside its cavity and is therefore not able to reconstitute bone losses in the upper maxilla, in particular in order to create bone around the implant placed in the maxillary sinus which still exists in mammals and in particular in humans. The implant described in the document is therefore incapable of creating bone in the cavity created in the bone.

The reconstruction of bone losses in the upper maxilla constitutes a major problem in maxillofacial surgery, particularly in cases of osseous atrophy of the upper maxilla in edentulous patients who are candidates for dental implants.

In order to fit an implanted-supported prosthesis to a patient with losses in the upper maxilla, it has usually been necessary to proceed in three distinct stages spread over a period of approximately one year:
1: Fitting of a graft by sinus lift or by apposition
2: Fitting of the implants
3: Fitting the implanted-supported structure (the dental prosthesis)

In order to provide a remedy for this disadvantage, the applicant in his application WO2004/054463 proposed an implant which after being fixed to a bony part allows the formation of bone in a non-osseous area so as to ensure excellent fixing of the implant, which can then serve as a base for an implanted-supported structure such as a dental prosthesis. The implant according to this application thus allows fitting even in bone heights considered insufficient for conventional implants. The implant comprises a structure with a coating which is osteogenic or capable of becoming osteogenic, the coating taking the form of a matrix with a solid armature, particularly an armature based on calcium phosphate.

The applicant has now noticed that by using a coating which is osteogenic or capable of becoming osteogenic including calcium sulphate of pharmaceutical quality it is possible to accelerate bone growth when providing vascular assistance of high quality and therefore a high degree of success in bone formation around the implant, even if the implant or part of the implant extends into an open cavity such a sinus. Large volume of bone tissue can be generated, with respect to the volume of the solid structure and its anchoring means.

The invention thus allows the rapid formation of a volume of reinforced bone (by the presence of the structure carrying the osteogenic coating) inside and outside an osseous cavity, whether natural or not, for example in a partially-osseous cavity, an intraoral cavity, a transosseous cavity or a periostal cavity such as a sinus, or in a cavity between two bone parts, but also in an air cavity, etc.

The fact that the structure with an osteogenic coating is designed to form a volume of reinforced bone after the structure is positioned provides rapid and reliable attachment between the structure and a significant volume of bone. The volume of bone formed from the osteogenic coating is advantageously at least equal to 25% of the volume of the structure and advantageously more than 50% of the volume of the structure and preferably greater than the volume of the structure, for example between one and ten times the volume of the structure.

General Description of the Invention

The implant according to the invention comprises a structure with a coating which is osteogenic or capable of becoming osteogenic, the said implant advantageously including a means of positioning or fixing able to engage with a living bony part or a part which can transform itself into bony tissue, such as a graft. In particular, the means of positioning is adapted in order to ensure positioning of the implant with respect to the living bony part, the said means of fixing being adapted in order to be in contact with at least one zone of a bony part and ensure colonisation of the osteogenic coating or layer by bone cells from a zone of the osseous wall adjacent to the zone in contact with the means of fixing or virtually exclusively from the zone of the osseous wall in contact with the said means of positioning. The implant according to the invention, because it allows osteogenesis from the vicinity of the means of positioning or fixing, is at least partially an extra-osseous implant and/or an implement extending at least partially into an air cavity. In addition, the implant according to the invention allows osteointegration when it is placed only in a bone graft or a graft of osteogenic material placed in a sinus or in the bone.

Preferably, the implant is an implant adapted for serving as base for at least a portion of a dental element selected from the group consisting of artificial teeth and dental prostheses after the at least partial placement of the implant through and in a hole of a living bony part of a bone structure selected from the group consisting of human upper maxilla and human lower maxilla, said implant comprising:

(a) a solid structure provided with anchoring means, said solid structure with its anchoring means having a volume,

(b) a layer which is osteogenic or capable of becoming osteogenic so as to form bone tissue after the at least partial placement of the implant through and in the hole of the living bony part, said layer coating the said solid structure and the anchoring means thereof, whereby ensuring an excellent anchoring of the structure with bone tissue after the formation thereof following the at least partial placement of the implant through and in the hole of the living bony part, whereby the said layer comprises calcium sulphate selected from the group consisting of calcium sulphate dihydrate, calcium sulphate alphahemidrate, and mixtures thereof,

(c) a means of positioning adapted to engage with said hole of the living bony part so as to ensure positioning of the implant relative to hole of the living bony part, and

(d) a fixing means attached to the said means of positioning, said fixing means being adapted for fixing said at least a portion of the dental element to the implant, whereby said layer is adapted for forming a volume of bone tissue corresponding to at least 50%, advantageously at least 100%, preferably between 100% and 300% of the volume of the structure with its anchoring means, and whereby the layer has a calcium sulphate content, expressed in anhydride form and after removal of free water, of more than 50% by weight.

Advantageously, the coating which is osteogenic or capable of becoming osteogenic includes calcium sulphate in its dihydrate or alphahemihydrate form or a mixture of these forms.

The coating which is osteogenic or capable of becoming osteogenic preferably includes calcium sulphate, advantageously in its dihydrate or alphahemihydrate form, mixed with a binder which advantageously is bio-resorbable. The binder thus forms a bond between grains or particles of calcium sulphate.

The binder contains for example at least a polymer binder, in particular a biopolymer binder, for example collagen, hyaluronic acid, thrombin or prothrombin, preferably a cellulose derivative such as carboxymethylcellulose.

In a preferred implementation, the coating which is osteogenic or capable of becoming osteogenic includes 50 to 95% by weight, advantageously 50 to 85% by weight and preferably 50 to 75% by weight of calcium sulphate expressed in the anhydride or Ca SO₄ form relative to the dry weight of the coating or the weight of the coating without free water, for example after a drying stage at 100° C.

According to a detail of an embodiment, the coating which is osteogenic or capable of becoming osteogenic includes calcium sulphate in the form of particles with a weight average particle size between 1 μm and 1 mm, advantageously between 5 μm and 750 μm and preferably between 10 μm and 250 μm.

In one particular aspect of an embodiment, the coating which is osteogenic or capable of becoming osteogenic after the elimination of any free water that may be present consists essentially of calcium sulphate in its hemihydrate and/or dihydrate form.

According to another detail, the coating which is osteogenic or capable of becoming osteogenic has pores with a number average diameter between 10 μm and 1000 μm, advantageously between 20 μm and 800 μm, preferably between 200 μm and 600 μm.

According to another detail of a preferred embodiment, the layer which is osteogenic or capable of becoming osteogenic has a bimodal porosity, said bimodal porosity being formed by a first series of pores with a diameter of less than 100 μm, said first series of pores having a number average diameter comprised between 15 μm and 75 μm, and a second series of pores with a diameter comprised between 101 μm and 100 μm, said second series of pores having a number average diameter comprised between 200 μm and 600 μm.

According to a particular aspect of an advantageous form, the coating comprises a material which is not resorbable or is weakly resorbable, advantageously in a proportion of between 0.1% and 25% by weight and preferably between 0.5 and 20% by weight relative to the total weight of the layer or coating comprising calcium sulphate in a form which is dry or anhydre or without free water. Preferably, the material which is not resorbable or is weakly resorbable is not or is weakly osteostimulative and in particular is hydroxyapatite. The hydroxyapatite may be of natural origin, for example from marine or terrestrial plants such as corals or coralloid organisms, or of synthetic origin, such as hydroxyapatite or dicalcium-deficient hydroxyapatites or hydroxyapatites with depleted dicalcium. Other non-osteostimulative materials include amorphous calcium phosphate, for example in the form of a sol gel (transition sol gel), crystals of dicalcium phosphate dihydrate or carbonated apatite.

In a preferred form of an implant containing hydroxyapatite, the ratio by weight of calcium sulphate expressed as anhydride/hydroxyapatite is between 20:1 and 1:1, advantageously between 15:1 and 2:1, said hydroxyapatite particles having advantageously a weight average particle size comprised between 1 μm and 1 mm, preferably between 5 μm and 750 μm, most preferably between 10 μm and 250 μm.

In the case where the implant contains a non-resorbable or weakly resorbable material (for example material or additive with less than 25% of resorption in 6 months), the non-resorbable or weakly resorbable material or additive, in particular hydroxyapatite, is in the form of particles with average particle size between 1 μm and 1 mm, advantageously between 5 μm and 750 μm and preferably between 10 μm and 250 μm.

In an advantageous form the coating or layer contains virtually no free water. The coating is for example placed in contact with a liquid medium before being implanted, for example with blood or a medium derived from blood, or with a liquid medium containing one or more agents or additives such as one or more antibiotics, growth factors, coagulation factors, etc.

In one embodiment, the coating or layer contains from 5 to 200% by weight of free water relative to the weight of the coating without free water, advantageously from 15 to 100% and preferably from 20 to 75% by weight of free water.

According to the details of forms of embodiment, the coating or layer includes at least one bone growth factor or factor controlling bone growth, and/or an antibiotic, and/or calcium phosphate and/or calcium carbonate and/or hydroxyapatite and/or tricalcium phosphate and/or an osteogenic ceramic and/or a material suitable for forming an osteogenic ceramic. The tricalcium phosphate, if it is used, is preferably in the beta form. The coating may also contain, in addition to the calcium sulphate, a mixture, for example a mixture of hydroxyapatite and tricalcium phosphate. The coating or layer may also take the form of an osteogenic ceramic containing calcium sulphate. The coating or layer may present the form of a dual-layer or multi-layer product, for example with a material situated between two layers or in a sandwich between two layers. The hydroxyapatite may for example be positioned between two layers of calcium sulphate (with or without hydroxyapatite).

The coating advantageously forms a network or scaffold or osteointegration structure.

The coating advantageously presents a macroporosity of between 100 and 600 microns which allows cellular invasion and osteoinduction.

The means of positioning and in particular of fixing to the living bony part advantageously present at least one channel or passage or groove suitable for ensuring osseous development from the osseous part or the living bony part towards the layer coating the structure, said layer being osteogenic or capable of becoming osteogenic. In particular, the channel or passage has a coating that encourages colonisation by cells generating bone or capable of generating bone and the transfer of cells to the layer coating the structure and its anchoring means. For example, the passage or channel has a coating similar to that used for the layer coating the structure. According to an embodiment the channel(s) or passage(s) contains a layer with a higher calcium sulphate content than the layer coating the structure, the calcium sulphate being calcium sulphate dihydrate and/or calcium sulphate alphahemidrate and/or mixtures thereof.

Advantageously, the implant or the means of positioning includes at least two separate channels or passages capable of ensuring osseous development from the osseous part towards the layer of the structure, said layer being osteogenic or capable of becoming osteogenic.

The channels or passages are preferably positioned in a manner that is broadly symmetrical with respect to the means of positioning and/or the fixing means.

According to a specific embodiment, the layer coating the structure is adapted in order to ensure the formation of bone tissue in a cavity outside the hole of said living bony part.

According to a further specific embodiment, the solid structure has a central longitudinal axis, and in which the layer coating said structure has a thickness measured perpendicularly to the central longitudinal axis of at least 1 mm.

According to still a further embodiment, the means of positioning is adapted to be placed at least partly into a hole of a living bony part, said hole having a lateral face, whereby the means of positioning has an outer surface adapted to contact at least partly the lateral face of said hole, said outer surface having at least one groove at least open towards the said layer coating the structure. Preferably, said outer surface having at least two distinct grooves at least open towards the said layer coating the structure.

In a particular embodiment, the implant has three channels or passages positioned in a manner that is broadly symmetrical with respect to the means of positioning or with respect to the fixing means. This ensures largely uniform colonisation of the coating which is osteogenic or capable of becoming osteogenic.

According to a detail of an embodiment, the means of positioning has an outer or external lateral surface that is broadly cylindrical or tapered with a thread able to engage in a thread in a hole formed in the living osseous part. The means of positioning is advantageously fixed by screwing into a hole made in the osseous wall, the said hole being advantageously threaded. The upper part of the means of fixing (part opposite the part of the means of fixing adjacent to the structure with a coating which is osteogenic or capable of becoming osteogenic) closes or fills the hole.

Advantageously, the channel(s) or passage(s) extend on the external lateral surface along an axis broadly corresponding to the generatrix of the lateral surface. According to an advantageous particularity, the channel or channels do not extend over the whole length of the lateral surface of the means of fixing.

In an advantageous embodiment, at least one channel or passage has a transversal cross section (section perpendicular to the central axis of the means of positioning) of at least 1 mm², advantageously more than 2 mm², for example 3 mm², 4 mm², 5 mm² or more, especially more than 10 mm².

In certain embodiments the total average flow cross section of the channel(s) (average measured along the length of the means of positioning, length measured parallel to the central axis) corresponds to at least 5%, advantageously at least 10% and preferably at least 15% of the average transversal cross section of the surface which is broadly cylindrical or tapered at the surface of which the channel or channels are formed. In particular, the flow cross section of the channel or channels corresponds to no more than 60%, advantageously to no more than 45%, preferably to no more than 30% of the average transversal cross section of the surface which is broadly cylindrical or tapered at the surface of which the channel or channels are formed.

For example, the implant presents a maximum width or diameter of less than 15 mm and a total length of less than 30 mm.

Advantageously, the structure with a coating which is osteogenic or capable of becoming osteogenic has one or more grooves and/or striations to encourage osseous colonisation, these grooves advantageously forming an extension of a passage or channel of the means of fixing, while the striations extend in a broadly perpendicular manner to the axis of the implant.

Advantageously, the means of fixing has a minimum diameter greater than the maximum width or diameter of the structure with a coating which is osteogenic or capable of becoming osteogenic. This allows the implant to be positioned in a single operation after having perforated the bone or the osseous wall through which the structure has to pass.

According to a specific embodiment, the solid structure has at least one surface element selected from the group consisting of grooves, striations and combinations thereof adapted to ensure an osseous colonisation of the said layer after the at least partial placement of the implant through and in the hole of the living bony part.

Preferably, the means of positioning and the solid structure have a central axis, in which the means of positioning has a substantially external lateral surface provided with at least one channel, in which the solid structure has grooves substantially parallel to the central axis, whereby at least one groove forms an extension of at least one channel of the substantially cylindrical lateral surface of the fixing means, and striations extending substantially perpendicular to the central axis.

According to a further specific embodiment in which the implant has a central axis extending at least in the means of positioning and in the solid structure, the means of positioning has an external surface which is substantially cylindrical, said means of positioning being defined at least by a minimum diameter. The layer coating the structure has an outer surface defined at least substantially by the rotation of a generatrix with respect to the central axis, whereby said outer surface of the layer coating the solid structure is located within a cylindrical volume defined by the central axis and said minimal diameter of the fixing means.

According to a detail of an embodiment, the implant has a linking means connecting the solid structure to the means of positioning, whereby this linking means is adapted to enable at least a relative movement between the means of positioning and the solid structure.

Preferably, in an embodiment in which the solid structure has an end portion away from the fixing means, whereby said end portion is located at a distance from the fixing means, the linking means is adapted for adapting the distance separating said end portion from the means of fixing.

According to a particularity, the implant includes a linking means connecting or linking the structure to the means of positioning, this linking means being adapted to permit relative movement between the means of positioning and the structure.

According to a further particularity, the implant includes a means adapted to modify the position of the fixing means with respect to the means of positioning, advantageously to modify axially (parallel to the central axis of the means of positioning) the position of the free end of the fixing means or an abutment portion of the fixing means with respect to the means of positioning.

In a variant in which the structure has an extremity away from the means of fixing, the implant includes a linking means connecting or linking the structure to the means of positioning, this means being capable of adapting the distance separating the free extremity of the structure relative to the means of positioning and thus to the fixing means.

According to a particularity of an embodiment, the fixing means or the postioning means includes at least one system to enable a protective cover or cap to be fitted in an immobile manner to the fixing means or to the means of positioning.

For example, the layer coating which is osteogenic or capable of becoming osteogenic has an average thickness of at least 500 μm, preferably at least 1 mm, most preferably at least 2 mm. The minimum thickness of the layer, thickness measured perpendicular to the central axis from the solid structure, especially from the anchoring means, is advantageously at least 500 μm.

The layer or coating which is osteogenic or capable of becoming osteogenic may contain one or more additives, such as bone growth factors and other substances such as substances able to prevent colonisation of the implant or the coating by bacteria, viruses or fungi, for example antibiotics, fungicides, bactericides, substances to encourage bone formation, such as calcium derivatives and in particular calcium triphosphate or precursors of that compound.

The subject of the invention is also a kit for preparing an implant according to the invention, the said kit including at least:
a structure such as defined for the implant according to the invention, and
at least one container containing a preparation which is ready to use or can be mixed with a medium, in particular an aqueous medium, to prepare a coating such as defined in the implant according to the invention

In particular, the kit of the invention is a kit for preparing an implant adapted for serving as base for at least a portion of a dental element selected from the group consisting of artificial teeth and dental prostheses after the at least partial placement of the implant through and in a hole of a living bony part of a bone structure selected from the group consisting of human upper maxilla and human lower maxilla, said implant comprising:

(a) a solid structure provided with anchoring means, said solid structure with its anchoring means having a volume,

(b) a layer which is osteogenic or capable of becoming osteogenic so as to form bone tissue after the at least partial placement of the implant through and in the hole of the living bony part, said layer coating the said solid structure and the anchoring means thereof, whereby ensuring an excellent anchoring of the structure with bone tissue after the formation thereof following the at least partial placement of the implant through and in the hole of the living bony part, whereby the said layer comprises calcium sulphate selected from the group consisting of calcium sulphate dihydrate, calcium sulphate alphahemidrate, and mixtures thereof,

(c) a means of positioning adapted to engage with said hole of the living bony part so as to ensure positioning of the implant relative to hole of the living bony part, and

(d) a fixing means attached to the said means of positioning, said fixing means being adapted for fixing said at least a portion of the dental element to the implant, whereby said layer is adapted for forming a volume of bone tissue corresponding to at least 50% of the volume of the structure with its anchoring means, and whereby the layer has a calcium sulphate content, expressed in anhydride form and after removal of free water, of more than 50% by weight,
the said kit comprising at least:
a supporting element comprising the solid structure, the positioning means and the fixing means, and
at least one container containing a compound selected from the group consisting of ready-to-use compounds for the preparation of the said layer and compounds adapted to be mixed with physiologically acceptable medium for preparing the said layer.
   The layer has advantageously one or more characteristics disclosed for layer of the implant of the invention, while the solid structure, the means of positioning and/or the fixing means has/have one or more characteristics disclosed for the implant of the invention.
   The invention further relates to a method for placing at least a dental element selected from the group consisting of artificial teeth and dental prostheses to a human in need, said method using an implant of claim 1 comprising at least the following steps:
   (a) forming a hole in a living bony part selected from the group consisting of human upper maxilla and human lower maxilla, whereby said hole transverses said living bony part,
   (b) placement of said implant through the hole of the living bony part, so that at least a portion of the solid structure and the layer extend outside the living bony part,
   (c) positioning the implant with respect to the living bony part by rotating the means of positioning with respect to the hole of the living bony part,
   (d) colonisation of the layer with bone stem cells of the living bony part so as to form bone tissue, and
   (e) after formation of bone tissue attachment of the dental element to the fixing means of the implant.
   In said method, the layer has advantageously one or more characteristics disclosed for layer of the implant of the invention, while the solid structure, the means of positioning and/or the fixing means has/have one or more characteristics disclosed for the implant of the invention.

Particularities and details of the invention are revealed in the following description, which makes references to the appended drawings.

### BRIEF DESCRIPTION OF THE DRAWINGS

In the drawings:

FIG. 1 is a side view of an intraoral implant

FIG. 2 is a view from below of the implant in FIG. 1 without the osteogenic coating

FIG. 3 is a view from above of the implant in FIG. 1

FIG. 4 is a view in cross section showing the installation of two implants according to FIG. 1

FIG. 5 is a magnified view of an implant during its osteointegration

FIG. 6 is a side view of an intrasinus implant

FIGS. 7 and 8 show the utilisation of the implant in FIG. 6

FIG. 9 shows a syringe for the additional injection of a preparation of calcium sulphate or another osteogenic gel

FIG. 10 shows another implant according to the invention

FIG. 11 is a magnified view of a cross-sectional detail of FIG. 1 along the line XI-XI

### DESCRIPTION OF PREFERRED EMBODIMENTS

The implant according to the invention reduces the time taken to position a graft, and even avoids a graft, as well as the time taken to fit an implant to be used as a support for the implanted-supported structure. The implant ensures good positioning of a support for osseous regeneration outside an osseous cavity and the fitting of implants in a single stage. According to the invention, it will no longer be necessary to take a bone sample or to graft material. The implant therefore allows the formation of a volume of reinforced bone inside and/or outside a bone, but also inside an air cavity.

In order to do this, the invention makes use of three important elements:
Osteointegratable implants of a particular structure, which constitute the first aspect of the invention, i.e. the solid structure 1, 6, 7, and
An artificial osteogenic substrate arranged on the implant, which constitutes the second aspect of the invention, i.e. the layer 2.

According to the invention, the coating or layer 2 (coating the solid structure 1,6 and its included anchor 7 providing an anchoring means) which is osteogenic or capable of becoming osteogenic comprises calcium sulphate. In particular, this coating is essentially constituted from calcium sulphate, preferably in its dihydrate form.

Although the coating based on calcium sulphate allows the rapid formation of newly-formed bone having the same characteristics as the bone of the subject or patient, one can add to the coating, for example before implantation or during the preparation of the coating or by impregnation of the coating, one or more particular additives, such as OP-1 made by STRYKER, OP-1 being part of the TGF β superfamily (Transforming Growth Factors beta). It is in fact indiscriminately called BMP 7 (Bone Morphogenetic Protein 7) or OP-1. OP-1, in conjunction with a carrier, allows bone of good quality to be generated in large quantities from the invented coating rich in calcium sulphate.

The preferred implants shown in the Figures present three major characteristics:
The two types of implant shown in the Figures will seek primary stability at the levels of bone which do not cover them completely
The osteointegratable implant parts which are not firstly anchored in the bone are covered with a synthetic osteogenic biomaterial rich in calcium sulphate of pharmaceutical quality
Osteointegration of the implant will be complete after total colonisation of the coating by newly-formed bone

The coating 2 is chosen to ensure good osteogenesis. The implants, in particular their solid structure including body 1, grooved surface 6 and anchors 7 (for example made of titanium), are arranged or adapted or configured in such a manner that they can fix or anchor the layer or coating 2 to their surface in an ideal fashion, while ensuring a good cell colonisation from the living bony part. It is arranged on the implant so that it can easily be colonised from the surrounding tissues. It has precise composition and physical properties, but is preferably gelatinous or able to become gelatinous. It is the support for one or more active agents to induce osteogenesis. The coating or layer 2 is solidly anchored to the implant, or more precisely to the solid structure 1,6,7.

The coating or layer 2 is sufficiently strong and stable to remain fixed to the implant during the handling operations to fit it and for the whole duration of osseous colonisation. This matrix or coating will gradually be replaced by the bone which will move along the implant from the surrounding tissues, as is explained in greater detail below. The colonisation generally takes place from the neck of the implant towards its apex (end opposite to the positioner 3 providing a means of positioning).

The coating or layer 2 is advantageously constituted from at least two distinct elements or advantageously comprises at least two distinct elements:
a matrix or a binder and
particles of calcium sulphate
   The Particles of Calcium Sulphate

The particles of calcium sulphate are particles in the form of dihydrate or alphahemihydrate and in particular in the dihydrate form.

The average particle size ranges from 10 μm to 250 μm, for example 25μ, 50 μm and 100 μm.

The Matrix or Binder in the Coating

Although the calcium sulphate particles are able stick to each other after the drying of an aqueous solution of calcium sulphate, it is advantageous to provide a binder or a matrix or a reinforcement in order to maintain the cohesion of the particles in the coating when the implant is fitted to the patient.

The binder is for example a polymer binder, in particular a cellulose derivative such as carboxymethylcellulose. In one embodiment, the binder is also capable of forming a gel when placed in contact with a medium containing water. Other possible binders are collagen, fibrin or recombinant compounds or polymerisable or polymerised or reticulatable or reticulated compounds or mixtures of these.

The binder is also useful for making an implant according to the invention, since it allows the formation of a gel with a viscosity selected according to the requirements.

The coating is microporous with pores or channels (of diameter below 100 μm) having an average diameter by weight between 20 and 70 μm, and/or macroporous with pores or channels having an average diameter by weight between 100 and 600 μm. This porosity is formed by free spaces between the particles when the particles are attached to each other by the binder. The level of porosity of the coating ranges from 15% to 50% of the volume of the coating.

Before being implanted, the implant with its coating is advantageously placed in contact with a medium, in particular a medium prepared from the blood of the patient or compatible blood or a medium originating from the blood of the patient or from compatible blood. One or more additives are advantageously added to the medium, such as antibiotics, growth factors, osteogenic factors and in particular recombinant human bone growth factors.

The coating or layer 2 serves to provide a certain volume around the structure, this volume being destined to be replaced by an approximately equivalent volume of bone tissue, said volume being advantageously at least equal to the volume of the solid structure 1,6 with the anchoring means 7. The main functions of the coating or layer 2 are:
to support the osteogenesis factors
to be resorbed by the tissues which colonise it
to ensure a sufficient volume of bone surrounding the solid structure 1,6,7,
to support one or more diverse agents such as antivirals, antifungals, antibacterials, growth factors, and mixtures thereof
to ensure continuity between the surrounding tissues and the coating itself for the osseous colonisation and vascularisation of the newly-formed tissue

The temporal and spatial stability of the coating and layer 2 at human body temperature, in particular before osteointegration, will ensure perfect osteointegration of the implant. By the choice of a coating based on calcium sulphate, it has been observed that it is possible to generate a bone volume which is greater than the volume of the coating. Once the bone is formed, the sinus membrane is capable of covering the newly-formed bone if required.

When the coating presents the form of a gel, the calcium sulphate is advantageously in a gel of collagen and/or fibrin and/or recombinant compounds or polymerisable or polymerised or reticulatable or reticulated compounds or mixtures of these etc.

The coating may also take the form of a hydrogel, a paste, a foam, a polymer substrate, polymerised and/or reticulated, a substrate prepared from synthetic and/or recombinant materials, a coating in a fluid or semi-fluid material or containing fluid or semi-fluid materials, or a combination of these forms.

The coating or layer 2 in the form of a gel or hydrogel, for example fibrin, collagen, etc. can be subjected to drying in order to form a porous structure in which the calcium sulphate is dispersed.

The coating including a binder therefore advantageously has a composite structure comprising a solid calcium sulphate phase in contact with another phase, for example porous or gelatinous, in particular a gelatinous phase in which the solid phase is dispersed.

It has been noticed that the solid calcium sulphate phase resists detachment of the coating during its fibroblastic colonisation. In particular, the solid phase will be able to resist detachment of the coating with respect to the surface of the structure of the implant, due to the deformation forces or loads caused by the retraction of the fibroblasts as they mature. Such a solid phase based on calcium sulphate also provides better osteointegration of the implant and/or a reduction or even prevention of incomplete or only partial osteointegration of the implant (or even the absence of osteointegration in certain cases). The coating will thus advantageously be able to avoid any detachment from the implant during fibroblastic maturation.

In an advantageous embodiment, the calcium sulphate particles present in the coating form a solid armature composed of granules or beads or spheres of calcium sulphate in contact with each other, if need be with an interposed adherent layer. These granules, spheres and beads or other particles have for example a particle size ranging from 10 μm to 250 μm.

These granules, spheres, beads and solid particles of calcium sulphate can be mixed if required with other solid particles made from various solid materials, for example artificial or synthetic materials, natural materials, biological materials, chemically and/or physically treated if appropriate. The material or matter mixed with the particles of calcium sulphate will preferably be biocompatible but not or weakly resorbable, and in particular non-osteostimulative or weakly osteostimulative i.e. not suitable for being replaced by bone tissue. An example of such particles is for example hydroxyapatite. When the coating includes hydroxyapatite, the ratio by weight of calcium sulphate expressed in the anhydride/hydroxyapatite form is advantageously in the range from 10:1 to 2:1.

The particles, granules, spheres etc. in the coating are advantageously bonded together by means of an adhesive or bridging layer so as to resist the forces generated by the fibroblasts during fibroblastic colonisation of the coating, these forces tending to deform the coating. The granular structure advantageously serves to support the osseous growth inducers of any nature.

The particles, granules, spheres etc. composed of or mixed with calcium sulphate are advantageously coated with a compound containing at least one binding agent, preferably of a gelatinous nature. The binder may for example be protein-based, such as collagen, hyaluronic acid (which in itself is a three-dimensional scaffold), prothrombin, etc. The binder is also advantageously chosen to encourage cellular colonisation.

The surface itself of the structure of the implants may be modified in order to ensure good adhesion of the coating or to form a favourable surface for bone formation. The surface can also be treated by electrolysis, mordanting or etching (attack by acid). The surface may for example be made porous, for example in order to make the surface itself osteogenic. Thus the support can be made, at least at the surface, in a hyperporous biomaterial with a pore diameter suitable for making the surface osteogenic, for example in porous titanium. The calcium sulphate content (expressed in anhydride form or CaSO₄) of the coating when dry or without free water ranges advantageously from 50 to 80%, the coating being for example essentially constituted from calcium sulphate in its dihydrate or alphahemihydrate form.

The average thickness of the coating is advantageously from 2 to 4 mm. The total volume of the coating is advantageously greater than the volume of the solid structure 1,6,7 around which the bone must form.

The coating or layer 2 based on calcium sulphate has a pumping effect on the osseous cells which encourages colonisation of the coating and its conversion into bone tissue.

The coating or layer 2 also serves as a means of protecting the titanium structure, in particular against external bacterial, fungicidal, viral and other contaminations. In addition, the use of calcium sulphate in orthopaedic surgery is well known.

It has thus been noticed that calcium sulphate is a suitable material for the formation of bone at maxilla level, in particular in the upper maxilla, even if the bone height is very small or even virtually inexistent, in particular with a part extending into an air cavity of the sinus. It has also been noticed that placing an implant according to the invention with a coating based on calcium sulphate in a sinus graft resulted in ossification of the coating and of the sinus graft.

The coating or layer 2 is advantageously applied to the structure by spraying, in one or more stages, followed by one or more drying stages. The partial coating may if necessary be dried after each spraying stage.

Addition of one or more osteogenic factors in the coating or layer

Although osteointegration of the coating or layer 2 based on calcium sulphate is already very rapid and reliable without adding any particular osteogenic factors, it may be useful in particular cases to add to the coating, or imbibe the coating with, one or more additional osteogenic factors.

These additional factors for osteogenesis of the coating or layer 2 can be of several types and several origins, but they mainly emerge from genetic engineering (recombinant human bone growth factors, etc.). All these factors are destined to be modified over the course of time in terms of their nature, their concentration, their preparation procedure, etc., in line with developments in the science. One might for example add only one osteogenic factor to the coating, such as OP-1, but it could become clear over the course of time, for whatever reasons, that other osteogenic factors or combinations of osteogenic factors, or even a combination of osteogenic factors with other elements, are more efficacious.

The addition of osteogenic factors allows patients with difficult osteointegration profiles to be spared one or more costly hospitalisations, pain and unforeseeable post-operative complications, at the same time as saving at least the six months necessary for the graft to take, since there is no longer any need for this, thanks to the implant according to the invention.

General Points on Edentulousness

The invented implant finds applications in the formation of bone in various sites of the human body, but in particular in the field of dental prostheses and the use of prosthetic apparatus in maxillary atrophies. It allows patients who are not candidates for sinus lift to be fitted with apparatus rapidly and at lower cost.

Total Edentulousness of the Upper Maxilla

Total edentulousness of the upper maxilla is a major handicap for patients who suffer from it and is widespread throughout the world. The number of potential candidate patients unfortunately rises every day.

The loss of teeth principally induces the disappearance of the periodontal bone, a loss of maxillary bone and pneumatisation of the maxillary sinuses. After a few years of wearing conventional removable prostheses, it is not rare to find patients with a virtually flat maxilla, reduced to the thickness of a cigarette paper, to which conventional prostheses no longer hold. In the posterior segment, where the molars and second pre-molar were located, the thickness of the maxillary bone may become less than one millimetre. This situation traditionally requires sinus grafts if one wishes to fit dental implants. This discourages many patients and practitioners from having recourse to implantation. The patients then find themselves trapped in a situation that is difficult to live with.

The present osteointegratable implants in these cases, because of the design and shape, require the grafts to be made several months prior to fitting the implants.

Conventional System for Grafts in the Upper Maxilla

It necessitates one (sometimes two) operations to lift the floor of the maxillary sinus (sinus lift), followed by a waiting period of six months for the graft to take. Only after this period can the implants be fitted. The time for osteointegration of the implant in the maxilla is approximately six months, after which the apparatus can be fitted to the patient. This makes a total of at least a year between fitting the first graft and the prosthesis being worn. The present invention will reduce these waiting times, thanks to the rapid and reliable colonisation of the coating of the implant according to the invention, even if part of the coating is in an air cavity or outside of the bone hole.

Sinus Lift

This surgical operation consists of filling the sinus by grafting elements which convert to bone. In the case of the present invention, fitting the implant will allow the installation in the required position of a structure with a suitable coating or layer for the rapid and reliable formation of bone, the implant rapidly becoming covered with bone, enabling the patient to be rapidly fitted with new teeth or a crown or other dental apparatus.

Partial Edentulousness of the Upper Maxilla

When one, two or even three upper molars are missing on the same side, together or not with premolars, one is often confronted with a lack of bone height. There often remains only two to five millimetres of bone height, or a little more or less. This is often insufficient for fitting implants by the conventional methods: the minimum accepted height is generally from 10 to 12 mm. One is then in a situation similar to the one described above for total edentulousness and sinus grafts have to be performed.

In the case of the present invention, fitting the implant will allow the installation in the required position of a structure with a suitable coating for the rapid and reliable formation of bone, the implant rapidly becoming covered with bone, enabling the patient to be rapidly fitted with new teeth or a crown or other dental apparatus.

The Invented Implant

The invented implant is an implantation system which is easy to use, can be produced industrially and is clinically reproducible, in order to benefit a maximum number of patients. The system allows rapid and controlled extra-osseous osteogenesis i.e. in a volume situated outside existing bone or an increase in the thickness of bone on which the implant is positioned, even in an air cavity. This avoids having to fit the implant only on the basis of existing bone, limited by the mechanical characteristics of the remaining bone part in which the implant is fixed.

The use of calcium sulphate of pharmaceutical quality in the coating or layer 2 according to the invention, in particular in the form of dihydrate, simplifies the procedures for fitting the implant while ensuring optimal security. The implant according to the invention is particularly suitable for the upper maxilla, because the choice of calcium sulphate enables it to ensure bone formation even for a part of the structure situated outside the bone, in particular in the sinus cavity, and even when the implant is not in direct contact with the bone but is placed solely in a sinus graft.

According to the invention, the structure of the preferred implants is profoundly modified relative to existing commercially available implant systems. They have particular characteristics which can not apply to conventional implants.

According to the invention, two types of preferred implant have been designed:
1: Implants to be fitted by intraoral methods
2: Implants to be fitted by intrasinus methods

These two types of implant are intended for two essentially different situations:
Intraoral implants to be fitted for minimum residual bone heights of 4 to 5 mm, for example up to 10 or 12 mm or more
Implants to be fitted by an intrasinus method can only be used if the residual bone height at the bottom of the sinus floor is less than 3 mm

This will allow the invention to be used for the majority of patients concerned by maxillary atrophy due to edentulousness.

General Points Concerning Implants According to the Invention

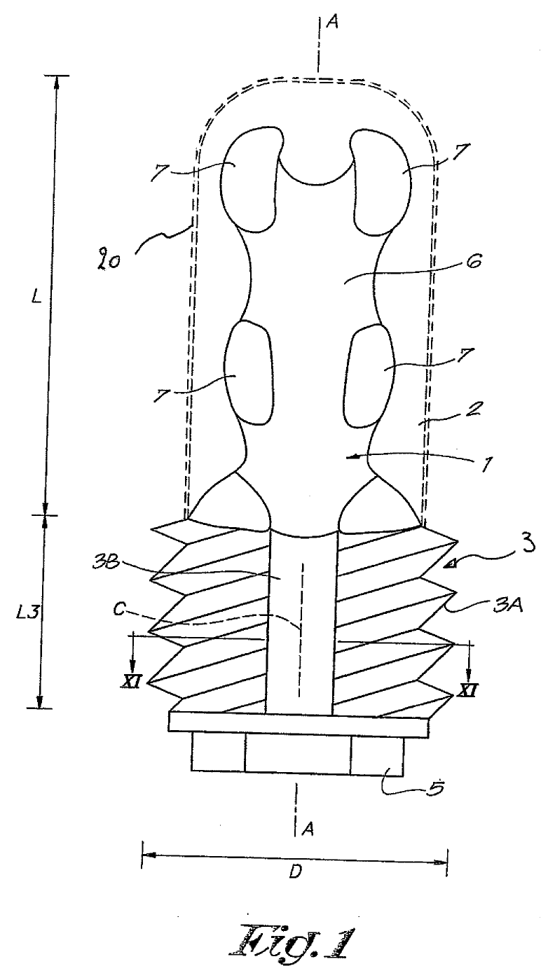

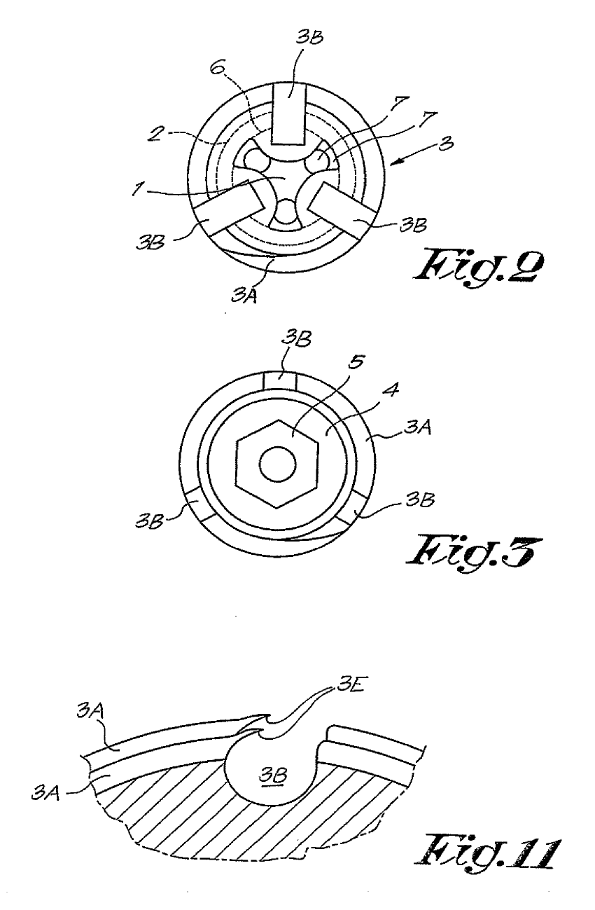

The preferred implants according to the invention shown in the Figures present the following advantageous particularities:
1: The surface states of the osteointegratable parts of the implants or structure 1,6,7 before being provided with the coating or layer 2 have the same characteristics as the implants sold at present and are advantageously treated in order to be porous or present one or more cavities or attachment zones
2: The parts of the implants that serve to receive the implanted-supported structures are standardised and can receive the materials sold by the manufacturer in order to avoid errors and reduce the number of parts
3: The solid structure before being provided with the osteostimulative coating or layer 2 is profiled in order to anchor the coating or layer 2 in an optimal manner, encourage bone colonisation and ensure excellent anchoring of the solid structure with the bone tissue once the latter has formed.
   Intraoral Implants (FIG. 1)

These implants are fitted intraorally in exactly the same way as other implants. The implants according to the invention have been configured to limit the opening of the sinus cavity and minimise the surgical intervention while ensuring a rapid formation of bone. As pointed out earlier, the part or platform which serves to fix the implanted-supported structures is standardised. This platform has for example the same characteristics as those of other implants sold by the manufacturer, which limits the number of parts and reduces costs.

The osteointegratable part according to the invention is significantly modified relative to conventional implants: according to the invention, it has three particularities:
1: A positioner 3 such as a screw thread 3A for fixing and positioning the implant to the bone (providing primary stability and positioning of the implant)
2: A solid part or structure 1 with a coating or layer 2 based on calcium sulphate (2)
3: A grooved surface 6 and/or channels 3B for bone regeneration or able to induce bone regeneration on the walls of the structure 1, these grooves and/or channels being coated or not with a coating or layer 2 encouraging the colonisation of cells inducing the formation of bone and/or a transfer of such cells to the coating or layer 2 of the structure 1

The grooves 6 in the structure 1 of the implant, from the emergence to the apex, allow a rapid bony colonisation of the coating based on calcium sulphate from the drilling hole thanks to the channels 3B.

Advantageously, the channels 3B can be filled partially or virtually completely with bone when the implant is fitted. This bone (in the form of particles or pieces) in the channels will colonise the coating or layer 2 to replace it by living bone.

The Coating or Layer 2 of the Intraoral Implant

The coating or layer 2 based on calcium sulphate is covered with a protective layer 20. After removal of the protective layer 20, the implant is screwed into the hole drilled in the bony wall. In a variant, before screwing the implant into the bony wall the coating is soaked in a medium which is at least partly aqueous, for example blood from the patient, to which medium has advantageously been added an antibiotic and/or an anticoagulant and/or bone growth factor(s).

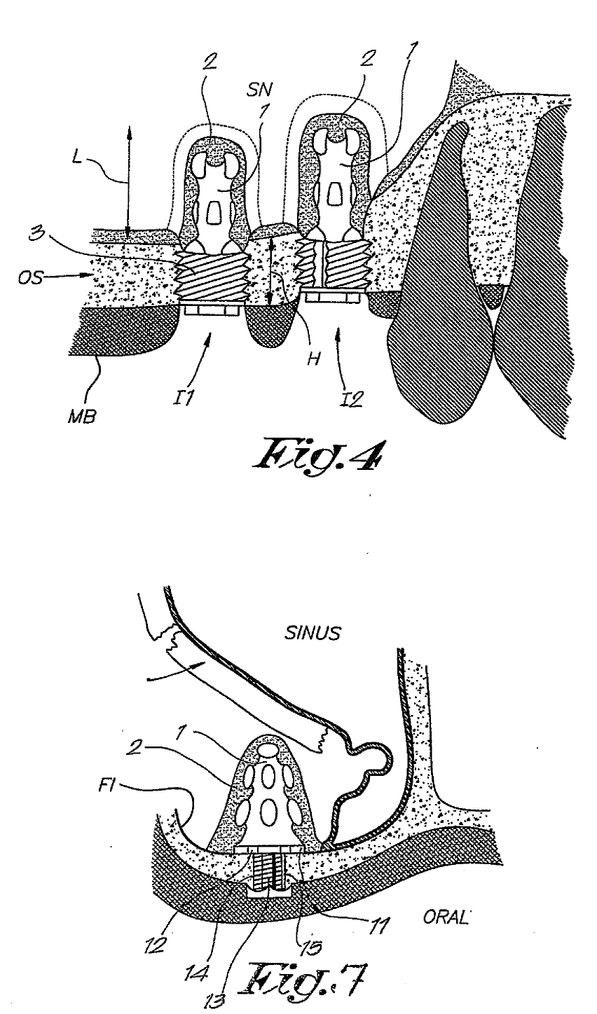

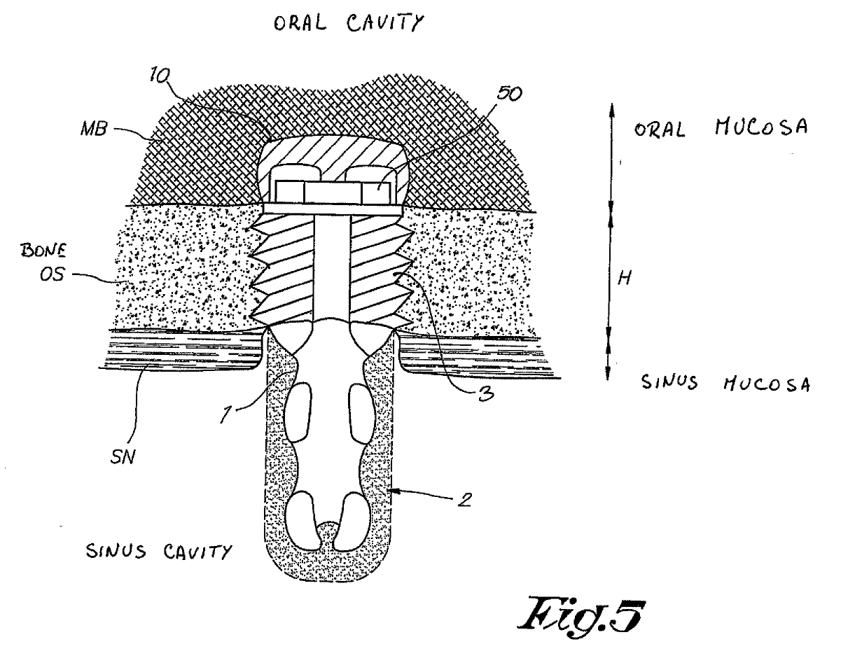

The implant is suitable for fixing to bone heights of approximately 5 mm or even more. This residual bone height provides the primary stability of the implant through the thread 3A of the means of positioning 3 screwed into a bony wall OS covered with the oral mucosa MB (see FIGS. 4 and 5). The rest of the implant (structure 1 and coating or layer 2 based on calcium sulphate with if appropriate a bio-compatible protective layer) emerges freely into the sinus cavity SN. The coating or layer 2 will be colonised by the bone so as to form an additional volume of bone, this additional volume of bone providing secondary stability of the implant once the additional bone volume has formed. Thus patients in limiting situations may be have apparatus fitted as easily as patients with sufficient bone heights, all the more so because osteointegration or formation of bone from the coating will be rapid.

The preferred implants shown according to the invention (which for example are monoblock) are essentially composed of three distinct parts (see FIG. 1):
The means of positioning 3 with thread 3A
The body or solid structure 1 and
The coating or layer 2 based on calcium sulphate

The coating or layer 2 may have a layer of a protective or outer coating 20 to protect the coating or layer 2. This outer coating (for example 20 in FIG. 1) may for example have a thickness from 10μ to 1000 μm or for example from 100 μm to 800 μm, and one or more particular properties (porosity etc.). This outer coating is intended to protect the coating or layer 2 in contact with the body 1, for example when the implant is fitted. The outer or protective coating 20 provides for example mechanical and/or biological protection (against bacteria, fungi, viruses, etc.) and/or contains elements suitable for ensuring the good development of bone tissue. This outer coating 20 is for example porous (porosity varying for example over the course of time between zero or low porosity to significant or total porosity), biocompatible and/or bio-resorbable, and/or with controlled or delayed release of one or more agents such as bone growth factors, antibiotics, antifungals, antivirals and mixtures of these.

The coating or layer 2 is applied to the surface of the body or structure 1, the said surface being advantageously treated so as to present surface porosity.

The Means of Positioning 3 for Positioning and Fixing the Implant to a Living Bony Part

The means of positioning advantageously includes a screw thread 3A designed to provide the implant with sufficient primary stability during its osteointegration. This screw thread 3A is traversed to the pitch of the screw by channels 3B dividing the screw thread 3A into segments and which channels 3B open into the longitudinal and circumscribing grooves of grooved surface 6 which lie adjacent the anchors 7 and go from the neck to the apex of the structure or body 1. The screw thread is preferably not provided with a calcium sulphate coating. The screw thread extends advantageously over a length (L3) of 4 to 7 mm. The channels 3B extend along an axis C parallel to the central axis A of the body 1 and of the direction of advancement provided by the means of positioning 3, and toward the grooves of the grooved surface 6 of the body 1. The channels 3B are advantageously filled at least partially with osteogenic gel or a compound based on calcium sulphate.

The channels 3B may not be completely filled with osteogenic gel or calcium sulphate. These channels then present or form a volume which is free to receive bone debris and blood factors when the implant according to the invention is fitted. This free volume will be of particular interest when the screw is of the tapping or self-tapping type. FIG. 11 shows a cross-sectional detail of the screw 3. As can be seen in this Figure, the external diameter of the thread 3A increases from its extremity adjacent to the body 1 towards its lower extremity carrying or extending to the flat 4. The channel 3B is partially formed in the thread so as to define in the thread a series of teeth or tapping edges 3E having an edge situated at a radius broadly corresponding to the average radius of a turn of thread which follows the edge. This leading edge thus cuts a groove in the bone, which facilitates the fixing of the screw once the groove has been formed. The leading edge is moreover profiled such that the bone debris formed by the cutting or tapping edge 3E is directed towards the channel 3B.

The positioner or other means of positioning advantageously includes, on its extremity opposite to that oriented towards the body or structure 1, a round flat 4 carrying a fixing nut 5 providing a fixing means for fitting the prosthesis and to allow the positioning means 3 to be screwed into the bone.

The channels 3B advantageously have a shape which is flared towards the body or structure 1. These channels are filled (partially or totally) or not with material capable of being colonised by the bone cells or of permitting the passage of bone cells towards the coating or layer 2.

The Body or Structure 1

This is the part which serves as a support for the coating or layer 2.

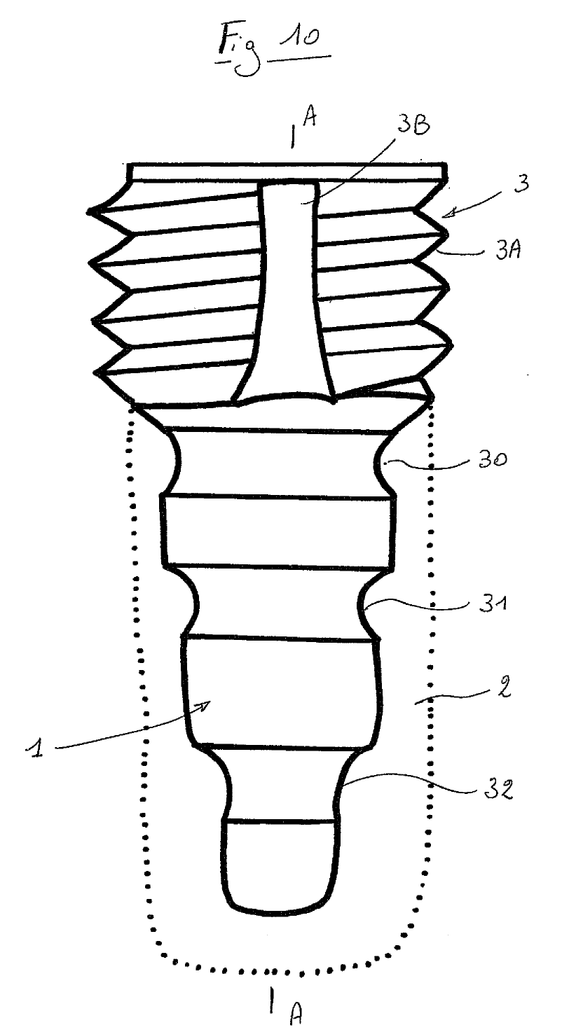

The body or structure 1 has a shape that can receive and anchor the coating or layer 2. This shape presents horizontal grooves or grooves perpendicular to the central axis A, and vertical grooves or grooves (for example, grooves 30, 31, 32 perpendicular to the central axis as shown in the embodiment of the structure 1A shown in FIG. 10, for example annular grooves) in grooved surface 6. These grooves, both parallel to the central axis of the structure 1 and perpendicular to that axis are designed to encourage bone colonisation (FIGS. 4 and 5). A part of the body or structure 1 with a coating 2 may emerge partially or completely into the sinus to partially or completely form bone outside the osseous cavity. The shape of the body or structure 1 is the subject of numerous modifications in order to facilitate the anchoring of the coating and its colonisation.

### Example No. 1

Fitting an implant of the type shown in FIG. 1 (with grooves 3B) with a diameter D of 5 mm and a total length of 12 mm; the bone height H of the sinus floor being 5 mm.

The positioner 3 has a height L3 of approximately 5 mm, a height at which the means is provided with a screw thread 3A. When the implant is fitted, the screw thread will be completely covered with bone and the coated part will emerge completely into the sinus cavity by 12-5 mm i.e. 7 mm (length L). Colonisation of the coating or layer 2 based on calcium sulphate will commence in the vicinity of the means of positioning 3. This colonisation will then be rapid up to the far extremity of the means of positioning 3 due to the cell pumping effect in the coating 2 (see FIG. 4, implant I1).

### Example 2

Fitting an implant 12 (see FIG. 4) as shown in FIG. 1 with a diameter D of 5 mm and a total length of 12 mm; the bone height H of the sinus floor being 7 mm.

The means of positioning has a height L3 of approximately 5 mm. The coating or layer 2 based on calcium sulphate is situated partly in the bony part over a height of 2 mm and the rest of the structure 1 with the coating or layer 2 emerges approximately 5 mm into the sinus. This is advantageous because the 2 millimetres of coating situated within the bony part will be easily colonised by the bone. In this case, the channels 3B extending across the screw thread 3A will have a subsidiary role in the colonisation of the coating.

The coating or layer 2 which is on the solid body 1 of the implant forms an outer envelope surrounding the solid body 1 of the implant, this envelope presenting a diameter less than the diameter D of the positioner 3, so that it can be inserted into the drilled hole without being damaged.

The grooved surface 6 may be provided with vertical channels or grooves (parallel to the central axis of the structure 1) which are arranged broadly over the whole length of the solid body 1 of the implant. The channels or striations 3B are arranged broadly over the whole length of the positioner 3 the said channels or striations 3B forming a passage between one extremity oriented towards one or more horizontal or vertical channels or grooves of the grooved surface 6 and an open extremity oriented towards a bony part in which the means of positioning is positioned and fixed. The horizontal grooves or channels of the grooved surface 6 may be annular and form junctions with the vertical grooves of the grooved surface 6.

The grooves of the grooved surface 6 (vertical and horizontal) are filled with calcium sulphate. Intrasinus colonisation will take place from the surface of the coating or layer 2 which is in contact with the bony tissue.

The numbers of grooves or channels 3B in the means of positioning is preferably, for example, between 1 and 5, with 3 being considered as optimal. The number of channels or grooves of the grooved surface 6 parallel to the central axis A may be different from the number of channels 3 B. When the implant is positioned, the channels 3B can serve secondarily as a tap drill. Osteogenesis or bone formation will mainly occur along the channels or grooves of the grooved surface 6. The formation of bone will also advantageously be broadly limited to a volume near the channels or grooves of the grooved surface 6, for example to a volume formed around the grooves corresponding to 1 to 10 times the volume based on calcium sulphate covering or filling the grooves.

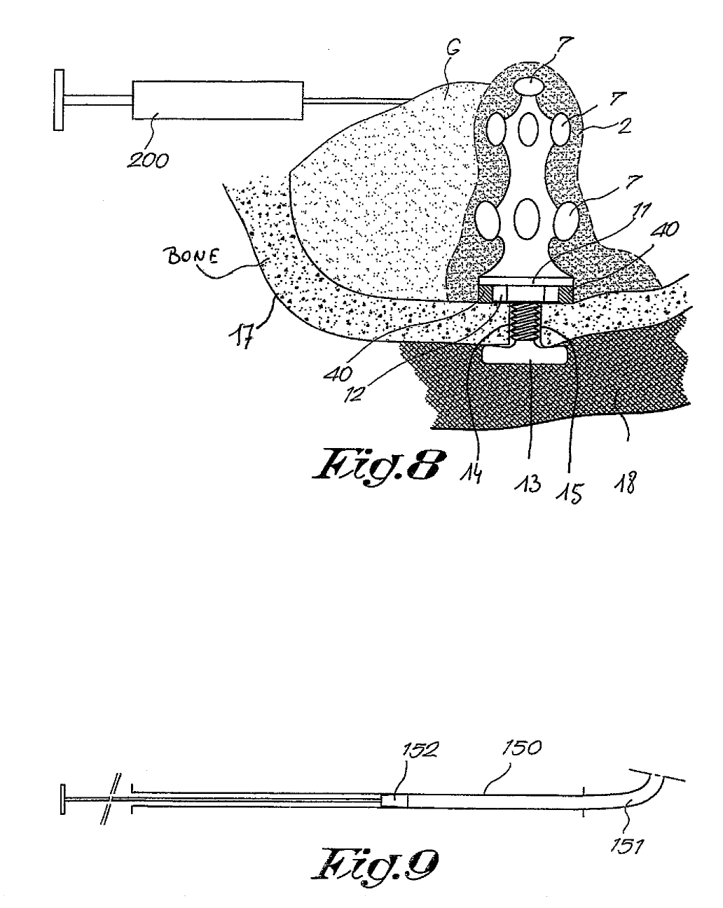

The bone stem cells colonise the coating or layer from a living tissue. In intraoral implants, the mucosa of the sinus is relatively respected and the tissues overlying the maxillary bone cannot enter into contact with the osteointegratable parts. The colonisation has no other choice than to start in the drilling hole in which the means of positioning 3 is placed. In the embodiment shown in FIGS. 6 and 8, in order to encourage colonisation, the grooved surface 6 between the anchors 7 is arranged over the whole length of the solid structure 1 of the implant. These grooves facilitate colonisation of the coating, from the drilling hole in the bony part in which the means of fixing is placed towards the apex of the implant. The coating based on calcium sulphate advantageously has a volume which is sufficient to ensure sufficient anchoring for the application of load to the implant and to ensure the durability of its use by a prosthesis.

Another type of body or solid structure 1 as shown in FIG. 4. may present a series of channels or grooves in the grooved surface 6 which are broadly parallel to the longitudinal axis of the body 1. The implant has a means of positioning 3 with a channel 3B or channels 3B as described in the embodiments in FIGS. 1, 5, etc.

The grooves or channels of the grooved surface 6 have a narrow part at the surface of the body and a wider part away for the outer surface of the body. The narrow part has in transverse cross-section (in a plane perpendicular to the longitudinal axis of the body 1) a broadly rectangular shape, while the interior part has a broadly circular shape, the diameter of the interior part being greater (for example two times greater) that the width of the narrow part. The grooves or channels of the grooved surface 6 extend from the means of positioning to the anchor 7 at the free extremity (see FIG. 6).

These internal slots then also form anchor points for the layer 2 based on calcium sulphate which can be placed on the surface.

Dimensions and Sizes of the Implants

The implants are characterised for the practitioner by their length and their diameter. Intraoral implants be characterised or classified according the following parameters:
Their total length (L+L3) (length measured parallel to the central axis A)
The length of the screw thread (L3) of the means of positioning (length measured parallel to the central axis A)
The length of the solid body (L) (length measured parallel to the central axis A)
The diameter of the implant (D) (measured in a plane perpendicular to the central axis A)
The size of the channels 3B
The number of channels 3B
The minimum equivalent diameter of the structure 1
The type of coating or layer based on calcium sulphate 2
The tissue factor concentration in the coating or layer 2
The concentrations of various additives present in the coating or layer 2
Etc.

The total length of the implant is for example from 8 to 18 mm. Their optimal length lies between 12 and 15 mm. The length of the screw thread 3 ranges from 4 to 10 mm. The ideal length is 5 to 7 mm. The solid body extends over the rest of the length. The diameter of the implant is considered at the level of the screw thread, the diameter at the body (structure without its osteogenic coating) being smaller in order to leave a free volume for a layer of coating situated within a cylindrical volume of smaller diameter than the screw thread, so as to avoid damaging the coating when the structure of the implant is fitted, in particular the fitting of the structure outside the bone. The diameter of the implant in the vicinity of the means of positioning 3 is 3 to 7 mm, but a diameter of 5 to 6 mm is preferable

Intraoral Fitting of the Implants

Intraoral implants are fitted in exactly the same way as traditional implants, using the same instruments or special instruments if appropriate, with no additional manipulations, which is a significant advantage.

Traditionally, the periostal mucosa is cleared away and a series of drill bits creates a trans-osseous channel. In contrast to what is done with the present traditional systems, the operator will pass through the whole thickness of bone to reach the sinus cavity. These operations having been performed, the implant is fitted, as in all the systems marketed at present. If the bone height at the crest is at least 4 to 5 mm, primary stability of the implant is ensured by the means of positioning 3. An essential difference relative to the existing systems is that the implant according to the invention emerges into the sinus cavity.

A cover 10 is placed over the nut 5 or other means of fixing in order to cover and close the operation site. This cover 10 limits the quantity or oral mucosa MB growing over the means 5 serving as an attachment base for the prosthesis and avoids having to lift the oral mucosa MB in contact with this means 5 (see FIG. 5).

During osteointegration of the part of the implant situated in the bone and in the sinus, the coating based on calcium sulphate will be invaded and replaced by bone. After less than 6 months, the implant is completely osteointegrated and is rapidly ready to receive loads according to the conventional techniques.

The bone colonisation comes from the holes of channels 3B present in the means of positioning, along the recesses filled with bone fragments formed during the tapping at the site of the implant. For this reason the minimal length of the drilling hole is advantageously at least 4 to 5 mm.

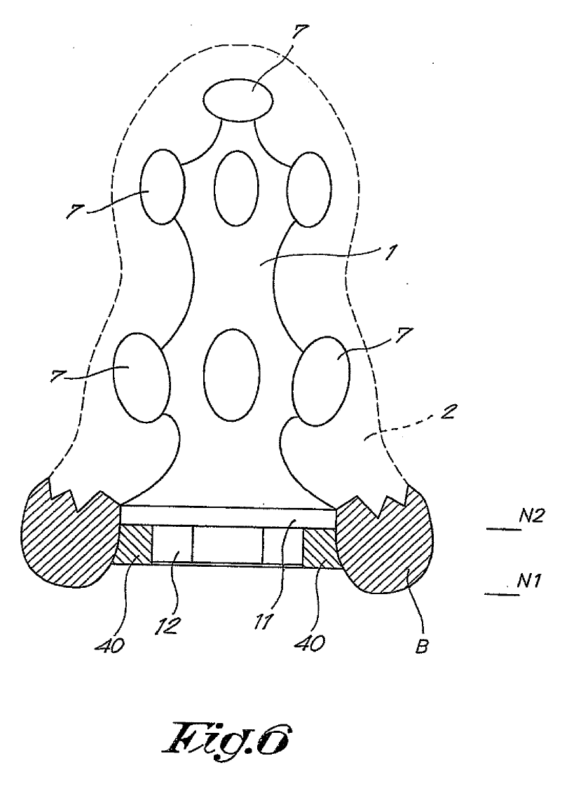

Intrasinus Implants (FIGS. 6 to 8)

These implants have a particular shape. Osteostimulation is produced by the patients own stem cells.

Their osteointegratable surface is entirely extra-osseous on fitting. Their osteointegratable surface is entirely covered with a layer based on calcium sulphate which will be completely colonised by newly-formed bone. Advantageously, one or more factors to induce osteogenesis are added to the layer.

They have a configuration which distinguishes them from the implants usually sold at present:
They do not have a screw thread at their surface to fix them in a hole made in the sinus floor
They are abundantly grooved from the neck to the apex of the implant

In effect, the grooves have to direct colonisation by bone cells or osteointegration from the sinus floor towards the apex of the implant, and secondarily by the soft tissues that come into contact with it by fenestration of the lateral wall of the sinus. Bone growth or osteointegration takes place in a sufficient volume to ensure good vascularisation of the newly-formed bone and the coating is solidly anchored. The osteointegratable surface is preferably as large as possible. If appropriate, the coating based on calcium sulphate will extend into a bone graft.

By way of example, the practitioner will have at his disposal a 200 cc syringe 150 containing a gel containing one or more osteogenic factors in a fluid mixture (possibly after mixing two distinct components) which can form a gel containing one or more osteogenic factors. This gel will be added in order to encourage bone colonisation of the coating 2 from the surrounding tissues and to form a larger bony volume. The gel will advantageously also contain calcium sulphate.

The implant will preferably be retentive for the coating based on calcium sulphate and will therefore have one or more protuberances which function as anchors 7 (FIG. 6).

The ribbing at the top of the solid structure 1 (FIG. 6) and the recess at the base will preferably be maximised, because:
Bone colonisation of the coating or layer and osteointegration will take place in the volume of the ribbing and the recess
The ribbing must have a sufficient volume

In contrast to intraoral implants, the coating based on calcium sulphate on the intrasinus implants will be colonised from the bone of the inner wall of the maxillary sinus and the surrounding soft tissues, with prolapse in the sinus cavity. It is well known that the stem cells reach the site through the blood.

Shape of Intrasinus Implants

The intrasinus implants as shown in FIGS. 6 through 8 have a particular shape. They preferably encourage optimal fixing of the coating, allow easy colonisation of the coating by bone and ensure sufficient osteointegration for the stable application of load over the course of time. The bone volume must be sufficiently large and correctly vascularised.

Length and Diameter of the Intrasinus Implants

The intrasinus implants as shown in FIGS. 6 through 8 advantageously have a length between 8 and 18 mm and a diameter from 3.8 to 7 mm.

Relative to the implant shown in FIG. 1, the structure 1 of FIG. 6 has a flat 11 designed to be in contact with the internal surface FI and includes a means 12 engage with a fixing and covering screw 13. This screw has a threaded shank 14 of which the extremity is engaged in the threaded hole of the means 12. The hole 15 formed in the wall of the sinus has a diameter greater than that of the shank 14. The coating or layer 2 covers the flanks of the flat 11 forming a slight bead B extending to a level N1 higher than the level N2 of the flat 11 designed to be in contact with a bony wall or the internal face of the bony part so as to ensure colonisation of cells via the contact between the coating 2 and the bony surface FI. To ensure the formation of an even greater volume of bone, it is possible to inject in the vicinity of the implant 1 a gel G or a solution capable of becoming a gel, this gel containing one or more osteointegration factors (see FIG. 8).

In order to avoid colonisation of the flat 11 or at least the section adjacent to the means 12, a ring 40 is attached to the said flat 11 or is placed on the said flat. This ring 40 is advantageously made from a friable material and contains one or more agents to oppose colonisation of the flat 11 (see FIG. 6).

Intraoral Fitting of the Implants

The mucosa of the operation site is detached. An opening 15 is cut in the lateral wall 16 of the maxillary sinus, respecting the underlying sinus mucosa SN. The osseous sinus window is pushed upwards, pushing back the sinus mucosa. and this mucosa is detached from the sinus floor 17. The mucosa 18 of the alveolar ridge is detached towards the palatine bone in order to clear the alveolar ridge. A bit is used to drill the hole 15 corresponding to the intended site of the implant 1. The surgeon places the implant 1 with its coating 2 in the sinus cavity and fixes it on the cover screw 13. The cover screw 13 is carefully tightened without completely crushing the sinus floor. This tightening operation ensures good contact between the bead B and the bone of the sinus floor. The surgeon can at this point using a gun or otherwise add a gel or an osteogenic compound to allow colonisation of the implant from the surrounding tissues, which will improve integration of the implant.

The primary stability of the implant lies in the thin residual bone layer of the sinus floor 17.

In this utilisation it is preferable for the implant to be covered immediately with a coating or layer based on calcium sulphate in order to limit the manipulations and ensure faultless coating of the implant.

The syringe of osteogenic gel or osteogenic product which is gelatable or can become a gel

The practitioner may find it useful to place the coating in the body without increasing the quantity of osteointegratable material, for example using a compound or gel based on calcium sulphate around the implant or around its coating in order to increase the quantity of bone around the implant and encourage bone colonisation of its coating from the surrounding tissues. He will have for this purpose a syringe containing a gel of calcium sulphate or a compound able to form an osteogenic gel. The syringe may have two or more compartments with a mixing system for the contents of the different compounds in the compartments before, and in particular just before, the injection. The gel will serve to create bridges from the sites which are conducive to regeneration. The bridges thus created will lead bone cells from the bone to the coating of the implant. This ensures an additional supply of bone cells for osteogenesis of the coating and to increase the probability of obtaining complete or virtually complete osteogenesis of the coating 2. The needle 151 of the syringe 150 (see FIG. 9) has a maximum diameter between 3 and 5 mm, with an internal passage diameter between 2 and 4 mm. The free end of the needle is curved. The volume of gel in the syringe is for example between 0.5 and 3 cm³. In order to limit the loss of products on the walls of the syringe, the diameter of the syringe will be limited for example to less than 1 cm and in particular to less than 0.7 cm. In the form illustrated, the syringe has an internal diameter corresponding to the internal diameter of the needle 151, so that the piston 152 is able to slide inside the needle and push virtually all of the gel present in the syringe and in the needle. In an advantageous implementation, the needle 151 and the body of the syringe are in one piece.

Clearing the Intrasinus Implants

During osteointegration of the structure 1, the oral mucosa covers the screw 13. In order to position an intermediate prosthesis support on the implant, the mucosa covering the screw 13 is removed. The intermediate support may either be placed directly on the screw 13 or on the implant. Once the support is in place, an impression can be taken of the superstructure that is to be attached to the implant.

FIG. 10 shows an implant similar to that in FIG. 1, except that the body has three grooves 30, 31 and 32 extending in a plane perpendicular to the axis A-A of the implant. The grooves have a diameter which reduces as the free extremity is approached.

The coating based on calcium sulphate of the structure can be fixed by physical and/or chemical and/or mechanical means of retention, or by any other means, including a combination of such means. The coating may be prepared by heating. The coating may be maintained in position by a mesh or braided or knitted or woven structure, for example a mesh of polygalactine 910, etc. or a structure made from any resorbable thread or by means of a porous substrate. In the case of a porous substrate, a liquid compound may be incorporated in the substrate.

In a particular manner according to the invention, the coating 2 is in the form of a gel or a pasty structure with or without an overcoating (single- or multi-layer). In this gelatinous form it advantageously meets several essential criteria:
It must have physical characteristics that keep it in place on the parts of the implant designed for the purpose, in time and in space
It must not deform at body temperature
It must be easily colonisable by the tissues intended to replace it, including by the bone tissue intended to replace it (it must not be a barrier to colonisation)
It is intended to be totally eliminated by the body

The coating or layer 2 is designed to be biologically colonised by the patient's bone tissue upon which the invention has been placed.

The coating is advantageously provided with an overcoating or an outer protective layer as described above. The overcoating is for example more slowly resorbed than the coating and has properties of controlled release of one or more growth factors, one or more antibiotics or one or more antifungals or mixtures of these.

The implants according to the invention may be in titanium or any other material of assembly of materials of any nature which is osteointegratable.

The invention enables implants to be placed in bone walls considered as insufficiently thick for conventional implants. The implants are intended to be partially covered by the patient's bone tissue. The present commercially-available implants have to be entirely covered with bone, whereas those described in the invention do not need to be.

The implants advantageously have a surface that is modified so that the coating can be fixed to the parts supporting it.

The implant advantageously has a shape designed to encourage optimal colonisation of the coating and is configured so as to encourage bone colonisation and the anchoring of newly-formed bone in order to ensure osteointegration compatible with the loads from prostheses.

The implants according to the invention shown in the Figures are not intraosseous when they are fitted. Their coating will become totally or partially replaced by bony tissue coming from the surrounding tissues.

For the fitting of an implant according to the invention comprising a means of fixing and a bone wall, a hole has to be drilled in the bone wall. This involves the use of known motorised devices with or without known types of drill bit.

The subject of the invention is also a kit for preparing the implant just before it is fitted.

The kit comprises:
a titanium implant with a body 1, the said implant being without a coating of calcium sulphate
a recipient containing calcium sulphate and carboxymethylcellulose
a syringe containing a quantity of mixing liquid such as sterile non-pyrogenic water
a spatula
if appropriate a phial containing an antibiotic

The recipient containing solid particles of calcium sulphate is opened and a quantity of water is added to it to form a gel or paste. The mixture is mixed using the spatula in order to make it homogenous. The antibiotic is added if appropriate.

The homogenous mixture is applied to the titanium body 1.

In a possible form of application, the mixture, once rendered homogenous, is mixed with particles of crushed bone from the patient or a compatible patient.

In yet another implementation of the kit, the titanium body of the implant has a pre-coating based on calcium sulphate. A wet layer of calcium sulphate (with or without an antibiotic and/or crushed bone) is then applied to the pre-coating of calcium sulphate.

1. An implant adapted for serving as base for at least a portion of a dental element selected from the group consisting of artificial teeth and dental prostheses after the at least partial placement of the implant through and in a hole of a living bony part of a bone structure selected from the group consisting of human upper maxilla and human lower maxilla, said implant comprising:
(a) a solid structure provided with anchoring means, said solid structure with its anchoring means having a volume,
(b) a layer which is osteogenic or capable of becoming osteogenic so as to form bone tissue after the at least partial placement of the implant through and in the hole of the living bony part, said layer coating the said solid structure and the anchoring means thereof, whereby ensuring an excellent anchoring of the structure with bone tissue after the formation thereof following the at least partial placement of the implant through and in the hole of the living bony part, whereby the said layer comprises calcium sulphate selected from the group consisting of calcium sulphate dihydrate, calcium sulphate alphahemidrate, and mixtures thereof,
(c) a means of positioning adapted to engage with said hole of the living bony part so as to ensure positioning of the implant relative to hole of the living bony part, and
(d) a fixing means attached to the said means of positioning, said fixing means being adapted for fixing said at least a portion of the dental element to the implant, whereby said layer is adapted for forming a volume of bone tissue corresponding to at least 50% of the volume of the structure with its anchoring means, and whereby the layer has a calcium sulphate content, expressed in anhydride form and after removal of free water, of more than 50% by weight.

2. The implant of claim 1, in which said layer is adapted for forming a volume of bone tissue corresponding to at least 100% of the volume of the structure with its anchoring means.

3. The implant of claim 1, in which the layer which is osteogenic or capable of becoming osteogenic comprises calcium sulphate selected from the group consisting of calcium sulphate dihydrate, calcium sulphate alphahemidrate, and mixtures thereof, and at least one binder selected from the group consisting of bio compatible binders, bio-resorbable binders and combinations thereof.

4. The implant of claim 1, in the layer has a calcium sulphate content, expressed in anhydride form and after removal of free water, comprised between 50% by weight and 85% by weight.

5. The implant of claim 1, in which the layer which is osteogenic or capable of becoming osteogenic comprises calcium sulphate selected from the group consisting of calcium sulphate dihydrate, calcium sulphate alpha hemidrate, and mixtures thereof in the form of particles with a weight average particle size between 5 μm and 750 μm.

6. The implant of claim 1, in which the layer which is osteogenic or capable of becoming osteogenic essentially consists of calcium sulphate selected from the group consisting of calcium sulphate dihydrate, calcium sulphate alpha hemidrate, and mixtures thereof.

7. The implant of claim 1, in which the layer which is osteogenic or capable of becoming osteogenic has pores with a number average diameter comprised between 20 μm and 800 μm.

8. The implant of claim 1, in which the layer which is osteogenic or capable of becoming osteogenic has a bimodal porosity, said bimodal porosity being formed by a first series of pores with a diameter of less than 100 μm, said first series of pores having a number average diameter comprised between 15 μm and 75 μm, and a second series of pores with a diameter comprised between 101 μm and 1000 μm, said second series of pores having a number average diameter comprised between 200 μm and 600 μm.

9. The implant of claim 1, in which the layer comprises a material which is not or is weakly resorbable, in a quantity between 0.1% and 25% by weight relative to the total weight of the layer without free water.

10. The implant of claim 1, in which the layer comprises hydroxyapatite particles with a weight average particle size comprised between 5 μm and 750 μm, the weight ratio calcium sulphate expressed as anhydride/hydroxyapatite being comprised between 20:1 and 1:1.

11. The implant of claim 1, in which the layer contains from 15% to 100% by weight of free water relative to the weight of the coating without free water.

12. The implant of claim 1, in which the layer contains at least one additive selected from the group consisting of bone growth factors, antibiotics, calcium phosphate, calcium carbonate, hydroxyapatite, tricalcium phosphate and mixtures thereof.

13. The implant of claim 1, in which the layer coating the structure is adapted in order to ensure the formation of bone tissue in a cavity outside the hole of said living bony part.

14. The implant of claim 1, in which the solid structure has a central longitudinal axis, and in which the layer coating said structure has a thickness measured perpendicularly to the central longitudinal axis of at least 1 mm.

15. The implant of claim 1, in which the means of positioning is adapted to be placed at least partly into a hole of a living bony part, said hole having a lateral face, whereby the means of positioning has an outer surface adapted to contact at least partly the lateral face of said hole, said outer surface having at least one groove at least open towards the said layer coating the structure.

16. The implant of claim 15, in which said outer surface has at least two distinct ones of said grooves which are at least open toward the layer coating the structure.

17. The implant according to claim 1, in which the means of positioning has an external lateral surface that is substantially cylindrical with a thread able to engage in a thread in the hole formed in the living bony part, and in which at least one channel extends on the substantially cylindrical external lateral surface along an axis substantially corresponding to a generatrix of the substantially cylindrical external lateral surface.

18. The implant according to claim 1, in which the means of positioning has an external lateral surface that is substantially cylindrical with a central axis and with a thread able to engage in a thread in the hole formed in the living bony part, whereby said means of positioning has a length measured parallel to the central axis and an average transversal cross section perpendicular to the central axis, said average transversal cross section being an average measured along the length of the means of positioning,
in which at least one channel extends on the substantially cylindrical external lateral surface along an axis substantially corresponding to a generatrix of the substantially cylindrical external lateral surface, and
in which at least one channel has a transversal cross section perpendicular to the central axis of at least 2 mm², a length measured parallel to the central axis and an average flow cross section of said at least one channel measured along the length of the said at least one channel corresponding to at least 5% of said average transversal cross section of the means of positioning.

19. The implant of claim 1, which has a maximum diameter of at least 15 mm and a total length of less than 30 mm.

20. The implant of claim 1, characterised in that the solid structure has at least one surface element selected from the group consisting of grooves, striations and combinations thereof adapted to ensure an osseous colonisation of the said layer after the at least partial placement of the implant through and in the hole of the living bony part.

21. The implant of claim 20, in which the means of positioning and the solid structure have a central axis, in which the means of positioning has a substantially external lateral surface provided with at least one channel, in which the solid structure has grooves substantially parallel to the central axis, whereby at least one groove forms an extension of at least one channel of the substantially cylindrical lateral surface of the fixing means, and striations extending substantially perpendicular to the central axis.

22. The implant of claim 1, in which the implant has a central axis extending at least in the means of positioning and in the solid structure, in which the means of positioning has an external surface which is substantially cylindrical, said means of positioning being defined at least by a minimum diameter,
in which the layer coating the structure has an outer surface defined at least substantially by the rotation of a generatrix with respect to the central axis, whereby said outer surface of the layer coating the solid structure is located within a cylindrical volume defined by the central axis and said minimal diameter of the fixing means.

23. The implant of claim 1, which has further a means selected from the group consisting of:
(a) a linking means connecting the solid structure to the means of positioning, whereby this linking means is adapted to enable at least a relative movement between the means of positioning and the solid structure,
(b) a system associated to the fixing means and adapted for fitting a protective cover in an immobile manner to the fixing means, and
(c) combinations thereof.

24. A kit for preparing an implant adapted for serving as base for at least a portion of a dental element selected from the group consisting of artificial teeth and dental prostheses after the at least partial placement of the implant through and in a hole of a living bony part of a bone structure selected from the group consisting of human upper maxilla and human lower maxilla, said implant comprising:
(a) a solid structure provided with anchoring means, said solid structure with its anchoring means having a volume,
(b) a layer which is osteogenic or capable of becoming osteogenic so as to form bone tissue after the at least partial placement of the implant through and in the hole of the living bony part, said layer coating the said solid structure and the anchoring means thereof, whereby ensuring an excellent anchoring of the structure with bone tissue after the formation thereof following the at least partial placement of the implant through and in the hole of the living bony part, whereby the said layer comprises calcium sulphate selected from the group consisting of calcium sulphate dihydrate, calcium sulphate alphahemidrate, and mixtures thereof,
(c) a means of positioning adapted to engage with said hole of the living bony part so as to ensure positioning of the implant relative to hole of the living bony part, and
(d) a fixing means attached to the said means of positioning, said fixing means being adapted for fixing said at least a portion of the dental element to the implant, whereby said layer is adapted for forming a volume of bone tissue corresponding to at least 50% of the volume of the structure with its anchoring means, and whereby the layer has a calcium sulphate content, expressed in anhydride form and after removal of free water, of more than 50% by weight,
the said kit comprising at least:
a supporting element comprising the solid structure, the positioning means and the fixing means, and
at least one container containing a compound selected from the group consisting of ready-to-use compounds for the preparation of the said layer and compounds adapted to be mixed with physiologically acceptable medium for preparing the said layer.

25. A method for placing at least a dental element selected from the group consisting of artificial teeth and dental prostheses to a human in need, said method using an implant of claim 1 comprising at least the following steps:
(a) forming a hole in a living bony part selected from the group consisting of human upper maxilla and human lower maxilla, whereby said hole transverses said living bony part,
(b) placement of said implant through the hole of the living bony part, so that at least a portion of the solid structure and the layer extend outside the living bony part,
(c) positioning the implant with respect to the living bony part by rotating the means of positioning with respect to the hole of the living bony part,
(d) colonisation of the layer with bone stem cells of the living bony part so as to form bone tissue, and
(e) after formation of bone tissue attachment of the dental element to the fixing means of the implant.
